(19) United States
(12) Patent Application Publication
(10) Pub. No.: US 2004/0051645 A1
(43) Pub. Date: Mar. 18, 2004

(54) Oven with television in the door

(76) Inventor: Gregory A. Mahloch, Omaha, NE (US)

Correspondence Address: Gregory A. Mahloch, Suite 110, PMB 288, 17330 West Center Rd., Omaha, NE, 68130, US

(21) Appl. No.: 10/243,767

(22) Filed: Sep. 16, 2002

(51) Int. Cl. G08B 3/00

(52) U.S. Cl. 340/691.6; 219/522

(57) ABSTRACT

This is an improvement to a microwave, convection, or any other oven. The oven would be equipped with a television screen in or on the door. The television screen could be wired to an antenna, cable television, satellite television or a pre-recording device (such as but not limited to a DVD player or VCR). The television screen could also be hooked to a closed circuit television to view the inside of the oven, or other rooms or areas. There is a clear advantage in having the television in an existing appliance because it will not take up any additional counter space or under cabinet space.

### BACKGROUND OF THE INVENTION

It is widely known that while a person is working in the kitchen that space (under cabinet space or counter space) is at premium. Many appliances are free standing and take up valuable under cabinet space or counter space. By combining two appliances into one appliance it will free up valuable under cabinet space or counter space for food preparation.

1. Field of Invention

This invention relates generally to cutting down the space needed for the appliances in the kitchen by combining two appliances into one. We have taken a television and installed it into or on the front door of the oven to free up needed food preparation space (under cabinet and counter space).

### SUMMARY OF THE INVENTION

This invention provides a way to clear the clutter from the kitchen and maximizing the under cabinet and counter space by combining two appliances into one, the television and the oven (microwave, convection or conventional) will take up less space. This space saving device will provide move freedom and convenience to any kitchen or room.

What is claimed is:

1. A microwave, convection or any other oven equipped with a television screen and related equipment in or on the door in order to view broadcast television stations (cable or regular) or any pre-recorded programming or closed circuit television to the occupants of the room.
